(19) United States
(12) Patent Application Publication
(10) Pub. No.: US 2021/0194790 A1
(43) Pub. Date: Jun. 24, 2021

(54) COMMUNICATION DEVICE AND COMMUNICATION METHOD

(71) Applicant: NIPPON TELEGRAPH AND TELEPHONE CORPORATION, Tokyo (JP)

(72) Inventors: Aki FUKUOKA, Tokyo (JP); Koji SUGISONO, Tokyo (JP)

(73) Assignee: NIPPON TELEGRAPH AND TELEPHONE CORPORATION, Tokyo (JP)

(21) Appl. No.: 17/267,760

(22) PCT Filed: Aug. 6, 2019
(86) PCT No.: PCT/JP2019/030978

§ 371 Date: Feb. 10, 2021

(30) Foreign Application Priority Data
Aug. 13, 2018 (JP) 2018-152531

(51) Int. Cl. H04L 12/755; H04L 12/28; H04L 12/46

(52) U.S. Cl. CPC H04L 45/021; H04L 12/4641; H04L 12/2856

(57) ABSTRACT

A storage unit stores SLG information (12a) being information about a network slice to which an own device belongs, and an SLG table (12b) that aggregates SLG information (12a) about other SLGs (10). A table creation unit (11a) updates, when receiving SLG the information (12a) about the other SLGs (10) from an adjacent SLG (10), the SLG table (12b) by using the SLG information (12a). An SLG information transmission unit (11b) adds the SLG information (12a) about the own device to the received SLG information (12a), and transmits the SLG information (12a) to another adjacent SLG (10).

### TECHNICAL FIELD

The present disclosure relates to a communication device and a communication method.

### BACKGROUND ART

A technique called network slicing (hereinafter also referred to as slicing) has been proposed in order to provide a network service that responds to various service requirements, such as a traffic, mobility, a capacity, the number of users, or a delay time (see NPL 1). Network slicing is a technique for separating a plurality of logical networks according to requirements from a common network infrastructure and independently managing these networks.

Network slicing has been achieved by control of a control device called orchestration.

### CITATION LIST

### Non Patent Literature

NPL 1: Shinya ARITA, Hidetaka NISHIHARA, Toru OKUGAWA, “A Study on Telemetry for Network Slicing”, IEICE Technical Report, vol. 118, no. 6, NS2018-3, April 2018, pp. 13 to 17

### SUMMARY OF THE INVENTION

### Technical Problem

However, when the orchestration is installed, all devices constituting a plurality of network slices need to be controlled by the orchestration, and links between all the devices and the orchestration are required. A cost of installation of the orchestration is divided proportionally in a large-scale system, and thus has a small influence. However, a proportion of such a cost to a cost of the entire system increases in a medium-scale system or smaller, and an influence is great. Further, a refloatation range is large during a failure of the orchestration.

The present disclosure has been made in view of the above-described problem, and an object is to construct network slices in which a plurality of logical networks are separated according to requirements from a common network infrastructure and independently managed without installation of an orchestration.

### Means for Solving the Problem

In order to solve the problem described above and achieve the object, a communication device according to the present disclosure is a communication device configured to be located in a network slice of network slices being logical networks satisfying predetermined requirements, and connect the network slice to virtual CPE or another network slice of the network slices, the virtual CPE being connected to a user terminal, the communication device being located in each of the network slices, the communication device including a storage unit configured to store slice information being information about the network slice to which an own device belongs, and a table that aggregates slice information about a communication device different from the own device, a table creation unit configured to update, when receiving, from an adjacent communication device, the slice information about the communication device different from the own device, the table by using the received slice information, and a transmission unit configured to add the slice information about the own device to the received slice information, and transmit the slice information to another adjacent communication device.

### Effects of the Invention

The present disclosure can construct network slices in which a plurality of logical networks are separated according to requirements from a common network infrastructure and independently managed without installation of an orchestration.

### BRIEF DESCRIPTION OF DRAWINGS

FIG. 1 is an explanatory diagram illustrating network slicing.

FIG. 2 is a schematic diagram illustrating a configuration of a system including a communication device according to the present embodiment.

FIG. 3 is a schematic diagram illustrating a schematic configuration of the communication device.

FIG. 4 is a diagram illustrating a data configuration of slice information.

FIG. 5 is a diagram illustrating a data configuration of a table.

FIG. 6 is an explanatory diagram illustrating processing of the communication device.

FIG. 7 is a flowchart illustrating a communication processing procedure.

FIG. 8 is a flowchart illustrating a communication processing procedure.

FIG. 9 is a diagram illustrating one example of a computer that executes a communication program.

### DESCRIPTION OF EMBODIMENTS

Hereinafter, embodiments of the present disclosure will be described in detail with reference to the drawings. Note that the present disclosure is not limited by the embodiments. In the drawings, the same parts are denoted by the same reference signs.

Network Slice

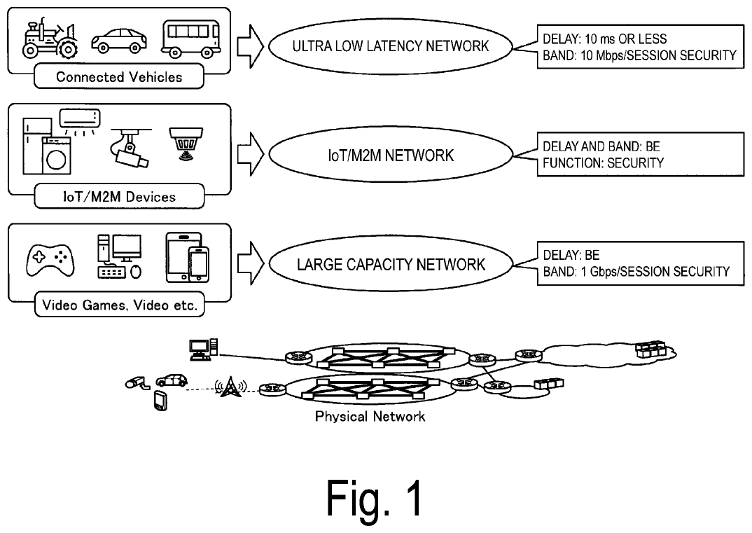

First, FIG. 1 is an explanatory diagram illustrating network slicing. Network slicing is a technique for separating a plurality of logical networks according to requirements from a physical network infrastructure and independently managing these networks.

For example, as illustrated in FIG. 1, an ultra low latency network that satisfies a requirement such as a delay of 10 ms or less and a band of 10 Mbps/session security is separated as a network slice for remote control of an automobile and the like. Further, as a network slice for Internet of Things (IoT) and machine to machine (M2M) connection, an IoT/M2M network that satisfies a requirement such as a delay and a band of best effort (BE) and a security function is separated. Further, a large capacity network that satisfies a requirement such as a delay of best effort and a bandwidth of 1 Gbps/session security is separated as a network slice for video games and video viewing.

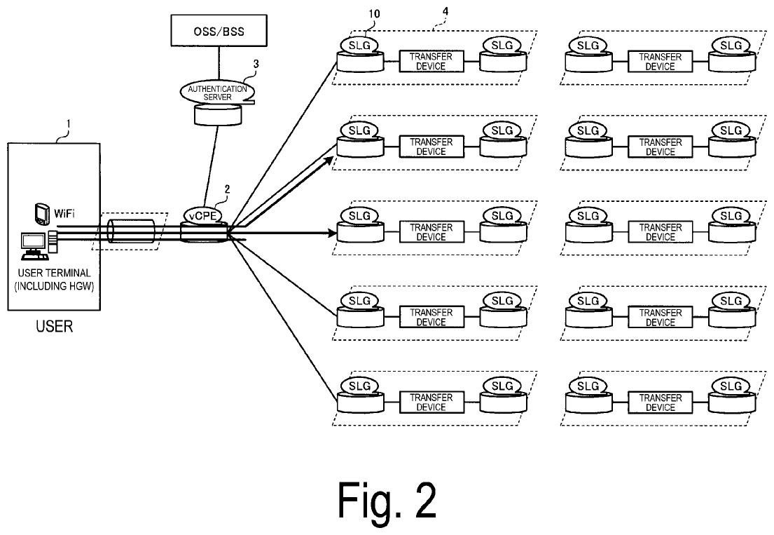

Next, FIG. 2 is a schematic diagram illustrating a configuration of a system including a communication device according to the present embodiment. As illustrated in FIG. 2, a user terminal 1 makes a connection request to virtual customer premises equipment (vCPE) 2 that is customer premises equipment (CPE) implemented on a virtualization platform.

The vCPE 2 acquires a requirement of a user such as information about a service level agreement (SLA) and information about necessary network functions virtualization (NFV) of the user from an authentication server 3 in an operation support system (OSS) and a business support system (BSS). Then, the vCPE 2 transfers a traffic of the user terminal 1 to a slice 4 according to the requirement of the user.

A slice gateway (SLG) 10 is located in each of the slices 4, and each SLG 10 connects between the vCPE 2 and the slice 4 or between the slices 4.

The communication device according to the present embodiment is implemented in the SLG 10. The SLG 10 is located for each of the slices 4 that satisfy a predetermined requirement, and connects this slice 4 with the vCPE 2 or another slice 4. The SLG 10 also autonomously connects between the slices 4 by communication processing described below, and transfers a traffic of the user terminal 1 to a slice 4 according to a requirement of the user.

Configuration of SLG

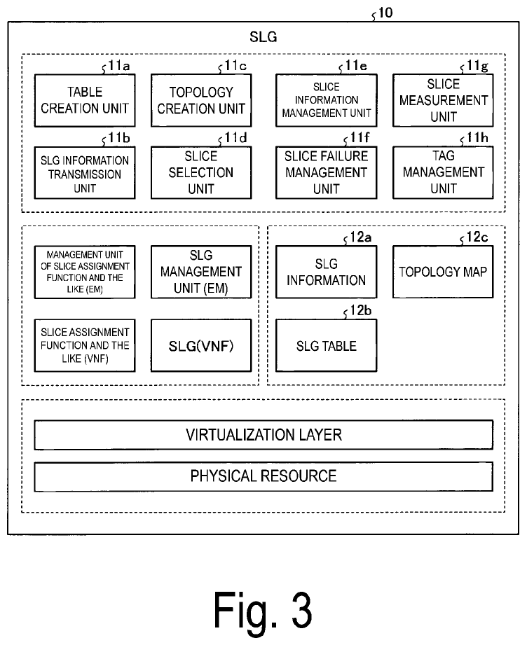

Next, FIG. 3 is a schematic diagram illustrating a schematic configuration of the communication device according to the present embodiment. As illustrated in FIG. 3, the SLG 10 being the communication device according to the present embodiment is virtualized and constructed on a physical resource implemented by a central processing unit (CPU), a network processor (NP), a field programmable gate array (FPGA), and the like.

The SLG 10 executes a processing program stored in a memory, and thus functions as an SLG (virtual network function (VNF)), a corresponding SLG management unit (element manager (EM)), a slice assignment function and the like (VNF), and a corresponding management unit of the assignment function and the like (EM), as illustrated in FIG. 3.

Here, as a gateway, the SLG (VNF) connects the slice 4 to which the own device belongs with the vCPE 2 or another slice 4. Further, the slice assignment function unit (VNF) transfers a traffic of the user terminal 1 to a slice 4 according to a requirement of the user.

The SLG 10 also functions as a table creation unit 11a, an SLG information transmission unit 11b, a topology creation unit 11c, a slice selection unit 11d, a slice information management unit 11e, a slice failure management unit 11f, a slice measurement unit 11g, and a tag managing unit 11h.

The SLG 10 further includes a storage unit constructed on a semiconductor memory element such as a RAM and a flash memory, and stores SLG information 12a, an SLG table 12b, and a topology map 12c.

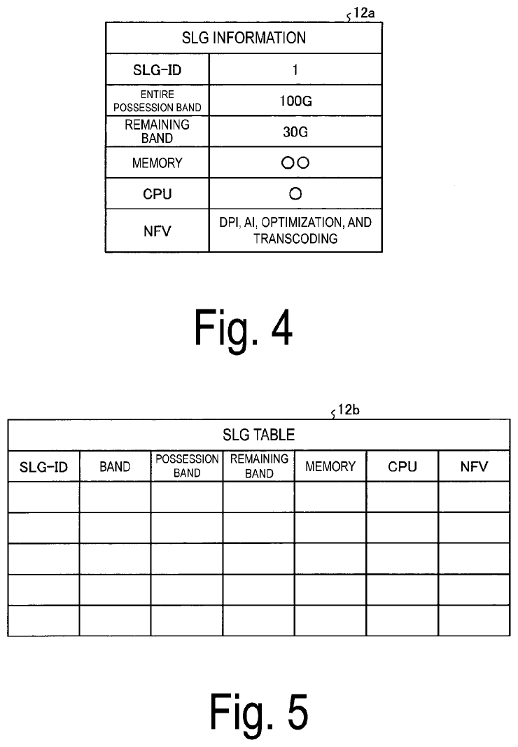

Here, FIG. 4 is a diagram illustrating a data configuration of slice information. The slice information, namely, the SLG information 12a is information about the slice 4 to which the SLG 10 belongs. For example, as illustrated in FIG. 4, the SLG information 12a includes an SLG-ID, an entire possession band, a remaining band, a memory, a CPU, and the like. The SLG-ID is information that identifies the SLG 10. The entire possession band represents a total of communication bands of all devices subordinate to the SLG 10. The remaining band represents a difference between the entire possession band and a band in use (usage band) of the subordinate devices. The memory and the CPU represent performance of the subordinate devices.

The SLG information 12a further includes an NFV. The NFV represents a capacity possessed by the slice 4 to which the SLG 10 belongs. Examples of the NFV include Deep Packet Inspection (DPI), AI, IoT server control, optimization, transcoding, and the like.

The slice information management unit 11e described below periodically collects information about the subordinate devices, and manages the information as the SLG information 12a.

FIG. 5 is a diagram illustrating a data configuration of the table. As illustrated in FIG. 5, the table, namely, the SLG table 12b aggregates the SLG information 12a about each of the SLGs 10. As described below, the table creation unit 11a periodically of updates the SLG table 12b, and holds the latest state.

A description is given with reference to FIG. 3 again. When the table creation unit 11a receives SLG information 12a about another SLG 10 from an adjacent SLG 10, the table creation unit 11a updates the SLG table 12b by using the SLG information 12a.

The SLG information transmission unit 11b also functions as a transmission unit. In other words, the SLG information transmission unit 11b adds the SLG information 12a about the own device to the received SLG information 12a, and transmits the SLG information 12a to another adjacent SLG 10.

Specifically, when the SLG information transmission unit 11b receives a plurality of pieces of SLG information 12a from an adjacent SLG 10, the SLG information transmission unit 11b adds the SLG information 12a about the own device to the end or the like of the received SLG information 12a, and transfers the SLG information 12a to another adjacent SLG 10. Further, the table creation unit 11a updates the SLG table 12b by using the plurality of pieces of SLG information 12a received from the adjacent SLG 10. In this way, each of the SLGs 10 can aggregate the SLG information 12a of all the SLGs 10 connected via an adjacent SLG 10, and manage the SLG information 12a as the SLG table 12b.

The topology creation unit 11c creates the topology map 12c representing a positional relationship with the other SLGs 10 by using the received SLG information 12a. In other words, the topology creation unit 11c determines, for example, an SLG 10 present several links away from the own device and SLG information 12a of the SLG 10 from the plurality of received pieces of SLG information 12a. In this way, the topology creation unit 11c creates, for example, the topology map 12c representing the positional relationship with the other SLGs 10 around the own device.

Note that, when the SLG information 12a includes information about an NFV, the SLG 10 can create an NFV map representing a location of the NFV by using the SLG information 12a and the topology map 12c.

The slice selection unit 11d functions as a selection unit. In other words, when the slice selection unit 11d receives a connection request of the user terminal 1 from the vCPE 2, the slice selection unit 11d selects a destination SLG 10 according to a requirement of the user by using the SLG table 12b and the topology map 12c.

Further, when the SLG information 12a includes information about an NFV, the slice selection unit 11d selects a destination SLG 10 according to the NFV included in the requirement of the user.

Further, when there is no SLG information about the SLG 10 corresponding to the destination in the SLG table 12b, the slice selection unit 11d selects a new SLG 10 and transmits a request to secure a resource. Then, the slice selection unit 11d receives a response to the request in which the SLG information 12a about the SLG 10 is added via the SLG 10 that has relayed the request to the new SLG 10. The plurality of SLGs 10 may be used for relaying.

In this case, the table creation unit 11a updates the SLG table 12b by using the received SLG information 12a about each of the SLGs 10. As a result, the SLG 10 can also update the SLG table 12b during communication of the user terminal 1.

Note that the slice selection unit 11d refers to information acquired from the slice information management unit 11e, the slice failure management unit 11f, and the slice measurement unit 11g when the slice selection unit 11d selects an SLG 10.

The slice information management unit 11e periodically acquires information about all the communicable devices subordinate to the own device, and manages the information as the SLG information 12a. The slice failure management unit 11f manages failure information related to all the devices subordinate to the own device. For example, the slice failure management unit 11f acquires failure information and notifies another SLG 10.

The slice measurement unit 11g measures a state of the other slice 4. For example, the slice measurement unit 11g transmits a packet to a new slice 4, measures a time required for a return, and acquires delay information and the like.

The tag management unit 11h applies a tag representing a requirement of the user to a packet to be transmitted to an SLG 10 selected by the slice selection unit 11d. For example, the tag management unit 11h applies a tag related to an SLI being a value of SLA information.

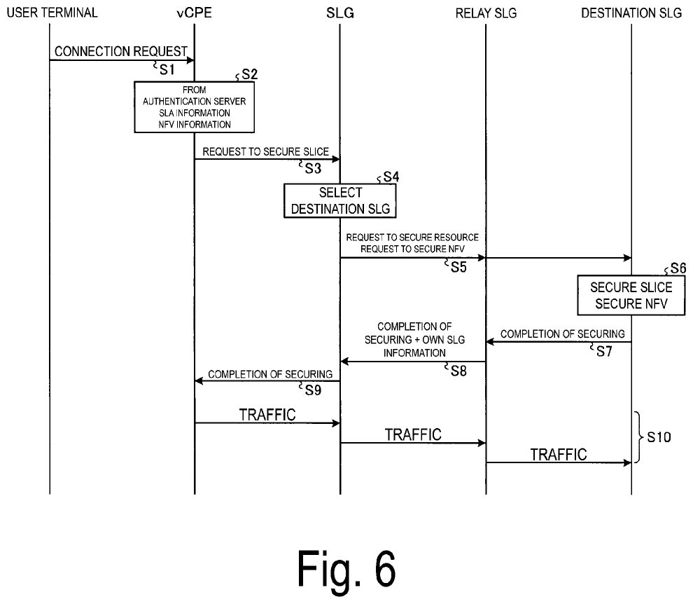

Here, FIG. 6 is an explanatory diagram illustrating processing of the communication device. FIG. 6 illustrates a case in which the SLG table 12b does not include SLG information about an SLG 10 corresponding to a destination of a connection request received from the vCPE 2.

First, when the vCPE 2 receives a connection request from the user terminal 1 (step S1), the vCPE 2 inquires of the authentication server 3, and acquires SLA information related to the user and required NFV information (step S2), and checks a requirement of the user. The vCPE 2 then transmits, to an SLG 10, a message of a request to secure a slice 4 according to the requirement of the user (step S3).

In the SLG 10 that receives the request to secure the slice 4 from the vCPE 2, the slice selection unit 11d refers to the SLG table 12b and selects a destination SLG 10. When an NFV is included in the requirement of the user, an SLG 10 according to the NFV is selected as a destination.

When there is no SLG information about the SLG 10 corresponding to the destination in the SLG table 12b, the slice selection unit 11d refers to information acquired from the slice information management unit 11e, the slice failure management unit 11f, and the slice measurement unit 11g, and selects a new SLG 10 as a destination (step S4).

The SLG 10 transmits a request to secure a resource to the new destination SLG via a relay SLG. When the NFV is included in the requirement of the user, the SLG 10 transmits a request to secure the NFV (step S5).

When the destination SLG has completed the slice securing (step S6), the destination SLG transmits a message of the completion of securing to the relay SLG (step S7). When the destination SLG is requested to secure the NFV, the destination SLG transmits a message of completion of securing to the relay SLG upon the completion of securing of the NFV.

The relay SLG that has received the message of the completion of securing transmits the message of the completion of securing to the request source SLG 10. At this time, the relay SLG adds the SLG information 12a about the own device (step S8).

The request source SLG 10 that has received the message of the completion of securing transmits the message of the completion of securing to the vCPE 2 (step S9). Further, the request source SLG 10 updates the SLG table 12b by using the received SLG information 12a about the relay SLG. In such a manner, each of the SLGs 10 can also update the SLG table 12b during communication of the user terminal 1.

Subsequently, a traffic of the user terminal 1 transmitted to the SLG 10 from the vCPE 2 is transmitted to the destination SLG via the relay SLG (step S10). Note that the relay SLG is not limited to one, and the plurality of relay SLGs may be used.

Communication Processing

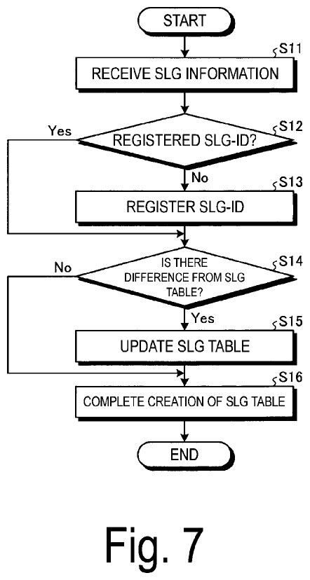

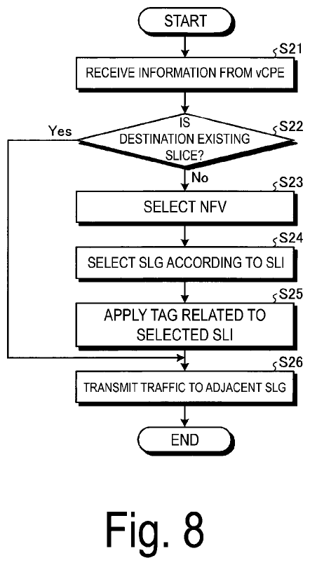

Next, FIGS. 7 and 8 are flowcharts illustrating communication processing procedures. FIG. 7 illustrates the communication processing procedure for creating the SLG table 12b in advance prior to communication of the user terminal 1. The flowchart illustrated in FIG. 7 starts, for example, periodically at predetermined intervals or at a timing instructed by an operator.

First, when the table creation unit 11a receives SLG information 12a about another SLG 10 from an adjacent SLG 10 (step S11), the table creation unit 11a checks whether the SLG-ID of the SLG information 12a is registered in the SLG table 12b (step S12). When the SLG-ID is not registered (step S12, No), the table creation unit 11a registers the SLG information 12a of the SLG-ID in the SLG table 12b (step S13).

On the other hand, when the SLG-ID is registered (step S12, Yes), the table creation unit 11a checks whether there is a difference from the SLG information in the SLG table 12b (step S14). When there is a difference (step S14, Yes), the table creation unit 11a updates the SLG table 12b by using the received SLG information 12a (step S15).

On the other hand, when there is no difference (step S14, No), the table creation unit 11a completes the creation of the SLG table 12b (step S16).

In such a manner, each of the SLGs 10 aggregates the SLG information 12a of all the SLGs 10 connected via the adjacent SLG 10, and manages the SLG information 12a as the SLG table 12b. This holds the SLG table 12b in the latest state.

Further, FIG. 8 illustrates the communication processing procedure for updating the SLG table 12b when the communication of the user terminal 1 starts. The flowchart illustrated in FIG. 8 starts at a timing when the vCPE 2 receives a connection request from the user terminal 1.

When the SLG 10 receives a request to secure a slice 4 including a requirement of the user from the vCPE 2 (step S21), the slice selection unit 11d checks whether a destination is one of the existing slices 4 that have already been registered in the SLG table 12b (step S22). When the destination has already been registered in the SLG table 12b (step S22, Yes), the slice selection unit 11d transmits a traffic of the user terminal 1 to an adjacent SLG 10 (step S26).

On the other hand, when the destination has not already been registered in the SLG table 12b (step S22, No), the slice selection unit 11d selects an NFV according to the requirement of the user (step S23), and selects an SLG 10 according to the SLI as a destination SLG (step S24).

Further, the table creation unit 11a updates the SLG table 12b by using the SLG information 12a about a relay SLG being added when the relay SLG that has relayed the request to the destination SLG relays a response.

Further, the tag management unit 11h adds a tag related to the SLI (step S25), and transmits the traffic of the user terminal 1 to the adjacent SLG 10 (step S26).

As described above, in the SLG 10 according to the present embodiment, when the table creation unit 11a receives SLG information 12a about another SLG 10 from an adjacent SLG 10, the table creation unit 11a updates the SLG table 12b by using the SLG information 12a. Further, the SLG information transmission unit 11b adds the SLG information 12a about the own device to the received SLG information 12a, and transmits the SLG information 12a to another adjacent SLG 10.

As a result, the SLG 10 aggregates the SLG information 12a of all the SLGs 10 connected via the adjacent SLG 10, and manages the SLG information 12a as the SLG table 12b. Therefore, the SLG 10 can autonomously connect between the slices 4 by using the SLG table 12b, and transfer a traffic of the user terminal 1 to a slice 4 according to a requirement of the user.

Specifically, the topology creation unit 11c creates the topology map 12c representing a positional relationship with the other SLGs 10 by using the received SLG information 12a. Further, when the slice selection unit 11d receives a connection request of the user terminal 1 from the vCPE 2, the slice selection unit 11d selects a destination SLG 10 according to the requirement of the user by using the SLG table 12b and the topology map 12c.

In such a manner, the SLG 10 according to the present embodiment can construct network slices in which a plurality of logical networks are separated according to requirements from a common network infrastructure and independently managed without installation of an orchestration.

Further, when the SLG information 12a includes information about an NFV, the slice selection unit 11d selects a destination SLG 10 according to the NFV included in a requirement of the user. In this way, the SLG 10 can distribute a traffic of the user terminal 1 to a network slice that performs appropriate NFV processing.

Further, when there is no SLG information about the SLG 10 corresponding to the destination in the SLG table 12b, the slice selection unit 11d selects a new SLG 10 and transmits a request to secure a resource. Then, the slice selection unit 11d receives a response to the request in which the SLG information 12a about the SLG 10 is added via an SLG 10 that has relayed the request to the new SLG 10. In this case, the table creation unit 11a updates the SLG table 12b by using the received SLG information 12a about each of the SLGs 10. As a result, the SLG 10 can also update the SLG table 12b during communication of the user terminal 1.

Program

A program in which the processing executed by the SLG 10 according to the embodiment described above is described in a computer-executable language can be created as well. As one embodiment, the SLG 10 can be implemented by installing a communication program for executing the communication processing described above in a desired computer as packaged software or on-line software. For example, by causing an information processing apparatus to execute the communication program described above, the information processing apparatus can be configured to function as the SLG 10. The information processing apparatus described here includes a desktop or laptop personal computer. In addition, a mobile communication terminal such as a smart phone and a mobile phone, and a slate terminal such as a Personal Digital Assistant (PDA) are included in the category of the information processing apparatus. The function of the SLG 10 may also be implemented in a cloud server.

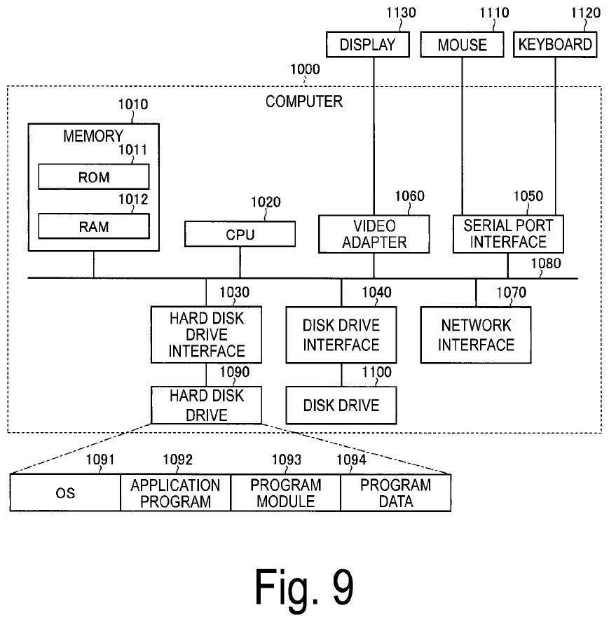

FIG. 9 is a diagram illustrating one example of a computer that executes a communication program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores a boot program, such as Basic Input Output System (BIOS), for example. The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. The respective pieces of information described in the aforementioned embodiments are stored in, for example, the hard disk drive 1031 and the memory 1010.

Further, the communication program, for example, is stored in the hard disk drive 1031 as the program module 1093 in which instructions to be executed by the computer 1000 are described. More specifically, the program module 1093 in which each processing executed by the SLG 10 described in the embodiment is described is stored in the hard disk drive 1031.

Further, data to be used in information processing according to the communication program is stored, for example, in the hard disk drive 1031, as the program data 1094. Then, the CPU 1020 reads the program module 1093 and the program data 1094 stored in the hard disk drive 1031 as needed in the RAM 1012 and executes each of the aforementioned procedures.

The program module 1093 and the program data 1094 related to the communication program is not limited to being stored in the hard disk drive 1031. For example, the program module 1093 and the program data 1094 may be stored on a detachable storage medium and read by the CPU 1020 via the disk drive 1041 or the like. Alternatively, the program module 1093 and the program data 1094 related to the communication program may be stored in another computer connected via a network such as a Local Area Network (LAN) or a Wide Area Network (WAN) and read by the CPU 1020 via the network interface 1070.

Although the embodiments to which the disclosure made by the present inventors is applied have been described above, the present disclosure is not limited by the description and the drawings as a part of the present disclosure according to the embodiments. In other words, all of other embodiments, examples, operation technologies, and the like made by those skilled in the art based on the present embodiment are within the scope of the disclosure.

### REFERENCE SIGNS LIST

1 User terminal
2 vCPE
3 Authentication server
10 SLG (communication device)
11a Table creation unit
11b SLG information transmission unit
11c Topology creation unit
11d Slice selection unit
11e Slice information management unit
11f Slice failure management unit
11g Slice measurement unit
11h Tag management unit
12a SLG information
12b SLG table
12c Topology map

1. A communication device configured to be located in a network slice of network slices being logical networks satisfying predetermined requirements, and connect the network slice to virtual customer premises equipment (CPE) or another network slice of the network slices, the virtual CPE being connected to a user terminal, the communication device being located in each of the network slices, the communication device comprising:
a storage configured to store slice information being information about the network slice to which an own device belongs, and a table that aggregates slice information about a communication device different from the own device;
a table creator configured to update, when receiving, from an adjacent communication device, the slice information about the communication device different from the own device, the table by using the received slice information; and
a transmitter configured to add the slice information about the own device to the received slice information, and transmit the slice information to another adjacent communication device.

2. The communication device according to claim 1, further comprising:
a topology creator configured to create a topology map representing a positional relationship with the communication device different from the own device by using the received slice information; and
a selector configured to select, when receiving, from the virtual CPE, a connection request of the user terminal, a destination communication device according to a requirement of a user by using the table and the topology map.

3. The communication device according to claim 2, wherein
the slice information stored in the storage further includes information about a necessary network functions visualization (NFV) possessed by the network slice to which the own device belongs, and
the selector selects the destination communication device according to an NFV included in the requirement of the user.

4. The communication device according to claim 2, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

5. A communication method performed by a communication device configured to be located in a network slice of network slices being logical networks satisfying predetermined requirements, and connect the network slice to virtual CPE or another network slice of the network slices, the virtual CPE being connected to a user terminal, the communication device being located in each of the network slices, the communication device including a storage unit configured to store slice information being information about the network slice to which an own device belongs, and a table that aggregates slice information about a communication device different from the own device, the communication method comprising:
creating, by a table creator, the table by updating, when receiving, from an adjacent communication device, the slice information about the communication device different from the own device, the table by using the received slice information; and
adding, by a transmitter, the slice information about the own device to the received slice information, and transmitting the slice information to another adjacent communication device.

6. The communication device according to claim 3, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

7. The communication method according to claim 5, the method further comprising:
creating, by a topology creator, a topology map representing a positional relationship with the communication device different from the own device by using the received slice information; and
selecting, by a selector, when receiving, from the virtual CPE, a connection request of the user terminal, a destination communication device according to a requirement of a user by using the table and the topology map.

8. The communication method according to claim 7, wherein
the slice information stored in the storage further includes information about an NFV possessed by the network slice to which the own device belongs, and
the selector selects the destination communication device according to an NFV included in the requirement of the user.

9. The communication method according to claim 7, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

10. The communication method according to claim 8, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

11. A system for communication associated with a network slice of network slices being logical networks satisfying predetermined requirements, and connect the network slice to virtual customer premises equipment (CPE) or another network slice of the network slices, the virtual CPE being connected to a user terminal, the communication device being located in each of the network slices, the system comprises:
a processor; and
a memory storing computer-executable instructions that when executed by the processor cause the system to:
store, by a storage, slice information being information about the network slice to which an own device belongs, and a table that aggregates slice information about a communication device different from the own device;
update, by a table creator, when receiving, from an adjacent communication device, the slice information about the communication device different from the own device, the table by using the received slice information; and
add, by a transmitter, the slice information about the own device to the received slice information, and transmit the slice information to another adjacent communication device.

12. The system according to claim 11, the computer-executable instructions when executed further causing the system to:
create, by a topology creator, a topology map representing a positional relationship with the communication device different from the own device by using the received slice information; and
select, by a selector, when receiving, from the virtual CPE, a connection request of the user terminal, a destination communication device according to a requirement of a user by using the table and the topology map.

13. The system according to claim 12, wherein
the slice information stored in the storage further includes information about an NFV possessed by the network slice to which the own device belongs, and
the selector selects the destination communication device according to an NFV included in the requirement of the user.

14. The system according to claim 12, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

15. The system according to claim 13, wherein
the selector selects a new communication device and transmits a request to secure a resource when the table does not include slice information about a communication device corresponding to a destination, and receives a response to the request in which the slice information about the communication device is added via a communication device that relays the request to the new communication device, and
the table creator updates the table using the received slice information.

16. The system according to claim 11, wherein the network slices include the network slice and another network slice sharing at least in part a common physical network.

17. The system according to claim 11, wherein the predetermined requirements associated with one or more of:
a network latency,
a network bandwidth, and
a security function.

18. The system according to claim 11, wherein the network slice is used for one or more of:
a remote control of an automobile,
a control of Internet of Things (IoT),
machine to machine (M2M connection,
video games, and
video viewing.

19. The system according to claim 13, wherein the NFV provides one or more of:
a deep packet inspection (DPI),
an IoT server control,
optimization, and
transcoding.

20. The system according to claim 19, wherein the information about the network slice includes one or more of:
a possession band,
a remaining band,
a memory information,
a CPU information, and
the NFV.
